(19) United States
(12) Patent Application Publication
(10) Pub. No.: US 2007/0228021 A1
(43) Pub. Date: Oct. 4, 2007

(54) ADJOINING APPARATUS AND NOZZLE UNIT THEREFOR

(75) Inventors: Tatsuya Wagou, Tokyo (JP); Osamu Shindo, Tokyo (JP); Toru Mizuno, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 11/686,514

(22) Filed: Mar. 15, 2007

(30) Foreign Application Priority Data
Mar. 16, 2006 (JP) 2006-071907

(51) Int. Cl. B23K 26/00

(52) U.S. Cl. 219/121.63

(57) ABSTRACT

A nozzle unit for use in an adjoining apparatus which places a heat fused electrically conductive member in an adjoining position for adjoining a first member and a second member, thereby electrically adjoining the first member and the second member, the nozzle unit including: a tubular nozzle assembly having a containing space which contains the conductive member and an aperture which communicates with the containing space, through which the conductive member, contained in the containing space, is ejected to the adjoining position, and which has a diameter larger than a diameter of the conductive member; and a hold member for releasably holding the conductive member in the containing space; wherein the nozzle assembly includes a tubular guide area of an internal diameter same as the diameter of the aperture, in a region from the position of the conductive member, supported by the support member, to the aperture.

### BACKGROUND OF THE INVENTION

1. Field of the Invention

The present invention relates to an adjoining apparatus utilizing an electroconductive member for adjoining a first member to a second member, and a nozzle unit for use therein.

2. Related Background Art

In a producing process for a magnetic head, an electrode of a magnetic head slider and an electrode of a flexible shaft are adjoined by a soldering utilizing a solder ball. More specifically, these electrodes are adjoined by positioning the electrodes at an angle of 90°, positioning a solder ball between the electrodes and fusing the solder ball with a hot wire or the like, thereby electrically adjoining the electrodes. In the following, a prior soldering apparatus utilizing solder ball will be described with reference to the accompanying drawings.

FIG. 9 is a partial cross-sectional view of a suction nozzle for use in a soldering process utilizing a prior first soldering apparatus 300. The drawing illustrates a slider 309 of a substantially rectangular parallelopiped shape, and a flexture 311. A slider electrode 313 is provided on an end portion of the slider 309. The slider 309 is mounted on the flexture 311 of a thin plate shape, and a flexture electrode 315 of the flexture 311 extends so as to form an angle of about 90° with respect to the slider electrode 313. The soldering apparatus for soldering such objects has the following construction.

The soldering apparatus is equipped with a suction nozzle 301 of a conical tubular member, for conveying a solder ball 307 from a solder reservoir to the electrode to be soldered. The suction nozzle 301 is connected to an unillustrated suction source, and a suction force therefrom is applied, through an internal space 305 of the nozzle and a suction hole 303, to the solder ball 307, thereby suction holding the solder ball 307 at the distal end of the suction nozzle 301. The solder ball 307, sucked to the suction nozzle 301, is fused for example by an unillustrated laser beam, in a state supported in such a position as to contact the slider electrode 313 and the flexture electrode 315. The fused solder ball solidifies between the slider electrode and the flexture electrode, thereby electrically adjoining both electrodes. For reference, see Japanese Patent Application Laid-Open No. 2006-88192 (FIG. 3).

However, the aforementioned electrodes are becoming smaller together with the compactification of the magnetic head. In the aforementioned soldering apparatus 300, it is necessary to stably and securely bring the distal end of the suction nozzle 301 close to the electrodes in a state suction supporting the solder ball 307, but, with the reduction in the size of the electrodes, it has become difficult to support the solder ball 307 without contacting the distal end of the suction nozzle 301 with the electrodes. Therefore, a soldering apparatus of another type is proposed. In the following, structure of such another soldering apparatus will be described.

FIG. 10 is a partial cross-sectional view of the soldering apparatus of another type. In such soldering apparatus 400, a solid solder ball 407 is fused by heating, and the fused solder ball 407 is ejected onto a substrate thereby executing a soldering.

The soldering apparatus 400 includes a nozzle assembly 401, which has a nozzle 402 for ejecting a solder ball 407 and a nozzle main body 413 for supporting the nozzle 402, a reservoir 415 for storing solder balls 407, and a laser apparatus 417 for fusing the solder ball 407. The nozzle 402 has a shape pointed toward the distal end. An aperture 403 of a containing portion 405 provided in the nozzle 402 has an internal diameter smaller than the external diameter of the solder ball 407, and other parts of the nozzle containing portion 405 has an internal diameter larger than the external diameter of the solder ball 407. Therefore, a solid-state solder ball 407 introduced into the containing portion 405 of the nozzle 402 is supported in the containing portion 405 in the vicinity of the aperture 403.

Also into the containing portion 405 of the nozzle 402, a laser beam from the laser apparatus 417 is introduced through a laser introduction path 419 of the nozzle main body 413, and irradiates the solder ball 407 supported in the vicinity of the aperture 403, thereby fusing the solder ball 407. Then a compressed gas is supplied from an unillustrated compressed gas source into the containing portion 405, thereby ejecting the fused solder ball 407. See Japanese Patent Application Laid-Open No. 2004-534409 (FIGS. 1 to 4).

In the soldering apparatus 400 disclosed therein, as the solder ball 407 is fused in the containing portion 405 of the nozzle 402, the fused solder ball 407 may partially or totally stick to an internal wall of the containing portion 405 or to an external wall around the aperture 403. When the solder ball 407 sticks to the internal wall of the containing portion 405, a gap is formed between a solder ball 407 next introduced into the containing portion 405 and the internal wall of the containing portion 405, and the compressed gas may leak from such gap whereby the containing portion may be unable to maintain an appropriate internal pressure and may result in an insufficient ejection of the fused solder ball.

Also at the ejection of the fused solder ball 407, the fused solder ball 407 may be pulled by the surface tension of the fused solder member sticking to the internal wall and may be ejected into a direction displaced from an intended direction of ejection. Furthermore, the sticking solder member may cause a clogging of the aperture 403 of the nozzle 402.

### SUMMARY OF THE INVENTION

In order to solve the aforementioned drawbacks, it is necessary to replace the contaminated nozzle or to remove the solder material sticking to the internal wall or the external wall of the nozzle 402.

Therefore, an object of the present invention is to provide an adjoining apparatus and a nozzle unit therefor, capable of securely ejecting a conductive member, without a clogging of a conductive member such as a fused solder member in a nozzle assembly such as a nozzle or a sticking of the fused conductive member around an aperture. Another object of the present invention is to provide an adjoining apparatus and a nozzle unit therefor, capable of executing an adjoining without that a distal end portion of the adjoining apparatus or the nozzle unit comes into contact with a first member and a second member to be adjoined.

Still another object is to provide an adjoining apparatus and a nozzle unit therefor, capable of improving the precision of deposition.

More specifically, the adjoining apparatus and the nozzle unit of the present invention have the following structure.

A first aspect of the nozzle unit of the present invention is a nozzle unit for use in an adjoining apparatus which places a heat fused electrically conductive member in an adjoining position for adjoining a first member and a second member, thereby electrically adjoining the first member and the second member, the nozzle unit including:

a tubular nozzle assembly having a containing space which contains the conductive member and an aperture which communicates with the containing space, through which the conductive member contained in the containing space is ejected to the adjoining position, and which has a diameter larger than a diameter of the conductive member; and

a support member for releasably supporting the conductive member in the containing space;

wherein the nozzle assembly includes a tubular guide area of an internal diameter same as the diameter of the aperture, in a region from the position of the conductive member, supported by the support member, to the aperture.

A first aspect of the adjoining apparatus of the present invention is an adjoining apparatus which places a heat fused electrically conductive member in an adjoining position for adjoining a first member and a second member, thereby electrically adjoining the first member and the second member, the adjoining apparatus including:

a tubular nozzle assembly having a containing space which contains the conductive member and an aperture which communicates with the containing space, through which the conductive member, contained in the containing space, is ejected to the adjoining position, and which has a diameter larger than a diameter of the conductive member; and

a support member for releasably supporting the conductive member in the containing space;

a heating unit which provides the conductive member with heat by an irradiation with a heating ray thereby heating the conductive member; and

a control unit which synchronizes a timing of releasing the support by the support member and a timing of heating by the heating unit;

wherein the nozzle assembly includes a tubular guide area of an internal diameter same as the diameter of the aperture, in a region from the position of the conductive member, supported by the support member, to the aperture.

In the present specification, a synchronization of a releasing step (releasing by a hold releasing unit) and a heating step (heating by a heating unit) means to correlate timings of the releasing step and the heating step in time, and more specifically means to execute the heating step in such a manner that the solder member starts to fuse at a timing when the fused solder member and the hold releasing unit reach a positional relationship not causing a mutual interference. Therefore, the timing of release and the timing of irradiation need not be simultaneous and either one may be executed earlier.

Also in the present specification, the electrically conductive member means a member capable of electrically connecting members constituting objects of adjoining, for example a metal material or an alloy, such as a solder or gold.

The soldering method and the soldering apparatus of the invention hold the solid-state solder member in a position separated by a predetermined distance from a substrate, then releases the hold in such position, and provides the solder member in the air with a heating ray, and do not hold the fused solder member, thereby avoiding a contamination in the solder-holding unit such as a nozzle.

Also as the soldering is executed in a state where a solder hold-release member is separated from the electrodes, it is possible to prevent that the solder hold-release member contacts the electrodes constituting the objects of soldering, thereby avoiding the damage in the electrodes or in the solder hold-release member.

Furthermore, the nozzle assembly has an internal diameter substantially same as the diameter of the aperture over a range from a position where the solder member is supported by the support member to the aperture, and can therefore define the direction of ejection after the solder member is released from the support. Therefore, the precision in the position of deposition of the solder member can be improved.

### BRIEF DESCRIPTION OF THE DRAWINGS

FIG. 1A is a partial cross-sectional view of a soldering apparatus of an embodiment 1 in a state where a stopper is in a closed position;

FIG. 1B is a partial cross-sectional view of the soldering apparatus of the embodiment 1 in a state where the stopper is in an opened position;

FIG. 2 is a process flow chart of a soldering process;

FIG. 3 is a partial cross-sectional view of a soldering apparatus of an embodiment 2;

FIG. 4 is an elevation of an open/close unit having an electromagnetic solenoid type actuator;

FIG. 5 is a cross-sectional view illustrating a nozzle assembly utilizing an open/close unit utilizing a piezo actuator;

FIG. 6 is an elevation view illustrating another open/close unit utilizing a piezo actuator;

FIG. 7A is a partial cross-sectional view of a soldering apparatus of an embodiment 3, and FIG. 7B is a bottom view seen from a direction VIIB;

FIG. 8A is a partial cross-sectional view of a soldering apparatus of an embodiment 4, and FIG. 8B is a magnified view of a portion VIIIB;

FIG. 9 is a partial cross-sectional view of a first prior soldering apparatus; and

FIG. 10 is a partial cross-sectional view of a soldering apparatus of another type.

### DETAILED DESCRIPTION OF THE PREFERRED EMBODIMENTS

In the following, embodiments of the soldering apparatus of the present invention will be described with reference to the accompanying drawings.

### Embodiment 1

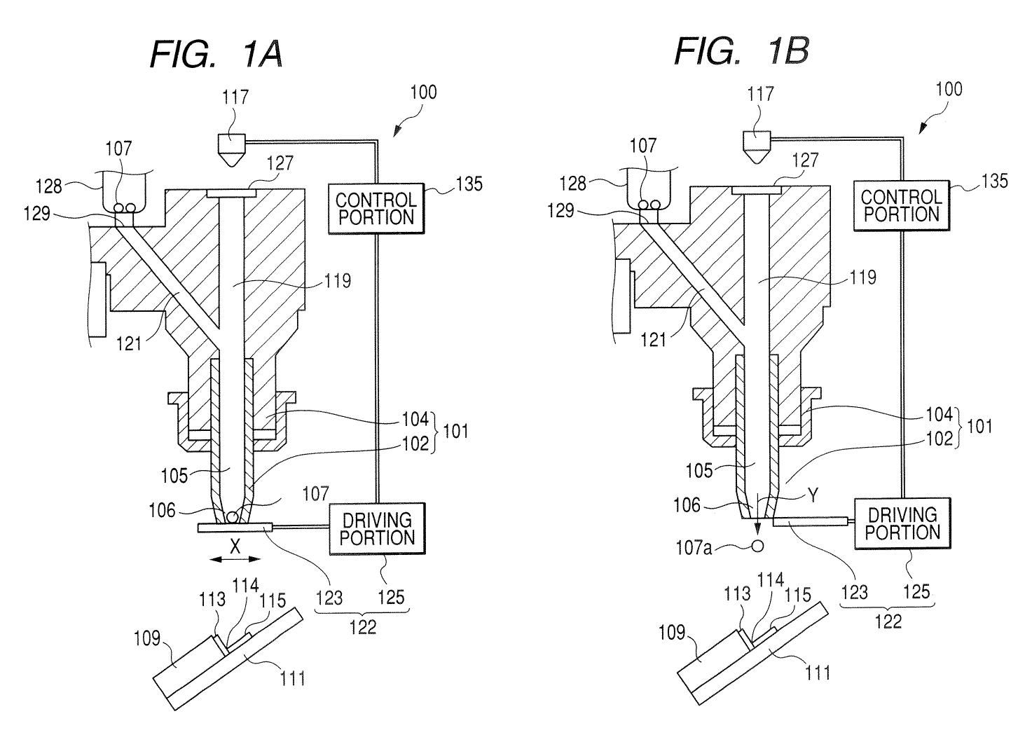

FIGS. 1A and 1B are partial cross-sectional views of a soldering apparatus embodying the present invention, wherein FIG. 1A illustrates a state in which a stopper is in a closed position, and FIG. 1B illustrates a state in which a stopper is in an open position. The embodiment illustrated in FIGS. 1A and 1B is an apparatus for soldering with a solder member which is a spherical solder ball 107, in order to electrically connect a substantially rectangular slider 109 for a magnetic head and a thin plate-shaped flexture 111 on which the slider 109 is to be mounted.

At first, structures of the slider 109 and the flexture 111, to be soldered, will be described. The slider 109 is provided, on an end face thereof, with a slider electrode 113 formed by a metal plate. On the flexture 111, provided is a flexture electrode 115 formed by a metal plate, and the slider electrode 113 and the flexture electrode 115 constitute an angled portion 114 of approximately 90°. The slider electrode 113 and the flexture electrode 115 are electrically connected by depositing a fused solder ball 107a in the vicinity of the angled portion 114 (FIG. 1B).

For soldering, it is necessary to deposit the solder member onto both the slider electrode 113 and the flexture electrode 115. Therefore, in order that the solder member is securely deposited onto both the slider electrode 113 and the flexture electrode 115, the angled portion 114 is utilized as a positioning V-shaped groove. In this manner, even when the position of ejection of the solder member is displaced from a predetermined position, the solder ball can be guided to the angled portion 114 by the surfaces of the slider electrode 113 and the flexture electrode 115. Thus, the fused solder ball is positioned, in a self-aligned manner, in the angled portion 114.

A soldering apparatus 100 includes a hold-release unit which releasably holds a solid-state solder ball 107 in a position, separated vertically upward by a predetermined distance from the predetermined position (angled portion 114) on the flexture electrode 115 where the solder member is to be deposited, a heating unit or a laser apparatus 117 which provides the solder ball 107 with a heat ray thereby heat fusing the solder ball 107, and a control unit 135 which synchronizes a timing for releasing the hold in the hold-release unit and a timing of heating by the heating unit.

The hold-release unit of the present embodiment is constituted of a nozzle assembly 101 and an open/close unit 122. The nozzle assembly 101 includes a nozzle 102 for ejecting the solder ball 107, and a nozzle main body 104 on which the nozzle 102 is mounted. Also the open/close unit 122 constituting the hold-release unit is constituted of a stopper 123 for open/closing an aperture 106 of a nozzle 102 to be described later, and a drive unit 125 for driving the stopper 123.

The nozzle 102 of the nozzle assembly 101 is a cylindrical member, containing therein a containing portion 105 for containing the solder ball 107, and having an aperture on both ends in the longitudinal direction. An end of the nozzle 102 in the longitudinal direction is mounted on the nozzle main body 104, and the other end constitutes an aperture 106 for ejecting the solder ball 107 to the exterior of the nozzle. Also the internal wall of the containing portion 105 of the nozzle 102 has a diameter at least larger than the external diameter of the solder ball 107, so that the solder ball 107 can freely roll and move in the nozzle 102. The aperture 106 has a diameter slightly larger than the external diameter of the solder ball 107, so that the aperture 106 also has a function of defining the position of the solder ball 107 in the lateral direction (direction X in FIG. 1A and direction Y (front-back direction with respect to the plane of FIG. 1B)). Therefore, a positioning of the nozzle 102 determines the position of the solder ball, present in the aperture 106.

The nozzle main body 104 is provided therein with a laser introduction path 119, which extends in a substantially vertical direction (gravitational direction) (top-bottom direction in the drawing), and which serves to guide the laser beam. An upper end of the laser introduction path 119 is closed by a laser introduction portion 127, which is formed by a glass material capable of transmitting the laser beam. A lower end of the laser introduction path 119 is connected to an end of the nozzle 102, whereby the laser introduction path 119 communicates with the containing portion 105. In the present embodiment, central axes of the laser introduction path 119, the nozzle containing portion 105 and the aperture 106 are present on a straight line.

The nozzle main body 104 is further provided with a solder ball introduction path 121, for guiding the solder ball 107 from a reservoir 128 to be described later to the containing portion 105 of the nozzle 102. The solder ball introduction path 121 is connected, at an end thereof, to a solder supply port 129 of the reservoir 128, and, at the other end, to the laser introduction path 119 of the nozzle main body 104. Therefore, the reservoir 128 and the laser introduction path 119 are connected by the solder ball introduction path 121. The solder ball introduction path 121 has an internal diameter larger than the external diameter of the solder ball 107, so that the solder ball 107 can roll.

Above the laser light transmitting portion 127 of the nozzle assembly 101, provided is a heating member which provides the solder ball 107 with a heat ray for heat fusing, namely a laser apparatus 117. The laser apparatus 117 is formed by a known apparatus, and is so constructed that the optical axis of a laser beam emitted from the laser apparatus 117 is aligned with the central axes of the laser introduction path 119, the nozzle containing portion 105 and the aperture 106. Therefore the laser beam passes through the laser light transmitting portion 127, enters the laser introduction path 119 of the nozzle main body 104, further passes the containing portion 105 of the nozzle 102 and proceeds through the aperture 106 to the exterior of the nozzle assembly 101.

An open/close unit 122 is provided vertically under the aperture 106 of the nozzle 102. A stopper 123 of the open/close unit 122 is moved by a drive unit 125, between a closed position, positioned directly under the aperture 106 and closing the aperture 106 (position in FIG. 1A), and an open position, moved from under the aperture 106 to the right-hand side in x-direction thereby opening the aperture 106. When the stopper 123 is in the closed position, the solder ball 107 introduced into the containing portion 105 is held by the internal wall of the nozzle 102 and the upper surface of the stopper 123. When the stopper 123 is moved rightward in x-direction by the drive unit 125, the aperture 106 of the nozzle 102 is opened whereby the solder ball 107 is ejected from the nozzle 102 (direction represented by an arrow Y in FIG. 1B). As the nozzle 102 is provided in a position which is separated vertically upward by a predetermined distance from the predetermined position (angled portion 114) where the solder ball 107 is to be deposited, the released solder ball is ejected toward such predetermined position.

The soldering apparatus 100 of the present embodiment further includes a control unit 135. The control unit 135 outputs a drive command signal for driving the drive unit 125 for the stopper 123 of the open/close unit 122, and an irradiation command signal for driving the laser apparatus 117, thereby synchronizing a drive start timing for the stopper 123 to the open position and a start timing of laser irradiation by the laser apparatus 117.

The soldering apparatus 100 is also connected to the reservoir 128 for storing the solder ball 107. The solder supply port 129 of the reservoir 128 is connected to an end of the solder ball introduction path 121 of the nozzle main body 104 in the soldering apparatus 100. Therefore, a solder ball 107, emerging from the solder supply port 129 of the reservoir 128, is guided, through the solder ball introduction path 121, into the laser introduction path 119 and the nozzle containing portion 105.

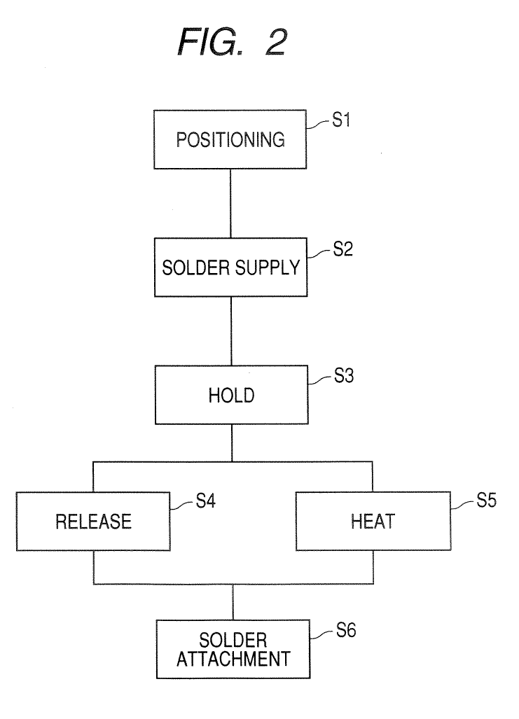

Now a soldering method embodying the present invention, utilizing the soldering apparatus 100 of the above-described structure, will be described with reference to FIGS. 1A, 1B and 2.

At first, the nozzle 102 is moved by an unillustrated moving mechanism, to a position separated vertically upward by a predetermined distance from the predetermined position on the flexture electrode where the fused solder ball 107a is to be deposited (step 1 (S1)). The moving mechanism utilizes, for example, a known structure capable of movement in three axes (x-axis, y-axis and z-axis). Also the positioning at the predetermined position is discriminated by imaging the nozzle and the objects to be soldered, utilizing a positioning camera, such as a CCD camera and a monitor for confirming the image from the positioning camera.

Then a solder ball 107 is introduced from the reservoir 128, through the solder introduction path 121 and the laser introduction path 119, into the containing portion 105 (step 2 (S2)). In this state, the open/close unit 122 is in a closed state, and the aperture 106 of the nozzle 102 is closed by the stopper 123. Thus the solder ball 107 is placed, in the containing portion 105, on the upper surface of the stopper 123 in the vicinity of the aperture 106, whereby completed is a holding step of holding the solid-state solder member in a position separated vertically upward by a predetermined distance from the depositing position for the solder member (step 3 (S3)).

In a next release step, the stopper 123 is moved rightward in x-direction, to release the hold of the solder ball 107, thereby executing an ejection from the aperture 106 onto a predetermined position on the flexture electrode 115, vertically downward in the drawing (step 4 (S4)).

In synchronization with the release step, a heating step is executed by providing the solder ball 107, having passed the aperture 106, with a laser beam from the laser apparatus 117, thereby executing a heat fusing (step 5 (S5)). The laser beam passes the laser transmitting portion 127, the laser introduction path 119, the containing portion 105 and the aperture 106 and heat fuses the solder ball 107 present in the air.

The solder ball 107a, fused in the air, is deposited on the angled portion 114 defined by the flexture electrode 115 and the slider electrode 113 (step 6 (S6)), thereby completing the soldering.

The above-described soldering method, executing the heat fusing of the solder ball 107 after it is ejected to the air outside the nozzle 102, can prevent the fused solder ball from sticking to the internal wall of the nozzle or to the periphery of the aperture 106.

The embodiment 1 above has such a construction that the entire solder ball is fused after passing the aperture and before reaching the angled portion defined by the flexture electrode and the slider electrode, but the present invention is not limited to such construction. For example a construction of partly fusing the solder ball may also be adopted. It is also possible to fuse the solder member only in a part thereof to be contacted by the object to be soldered, and, after the solder ball is stopped at the predetermined position, to continue laser irradiation thereby completely fuse the entire solder ball.

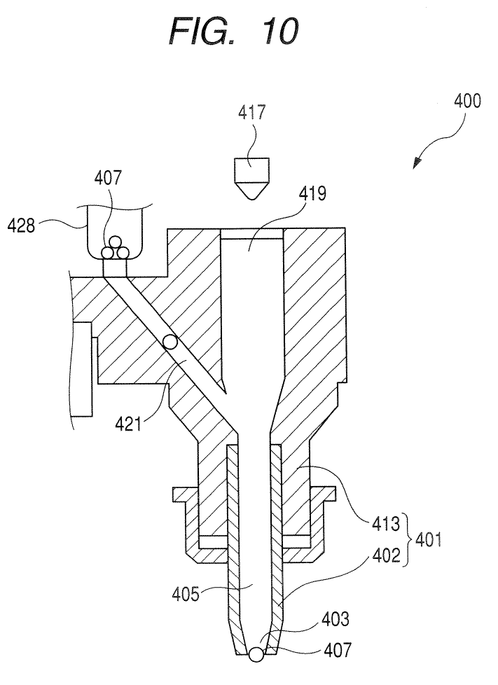

In case of a soldering apparatus 400, disclosed in Patent Reference 2 and described in relation to FIG. 10, for executing a soldering method of fusing the solder ball 407 in the containing portion 405 and then executing an ejection, a pressure of compressed gas to be used in ejecting the solder ball 407 has to be selected in consideration of the viscosity of fused solder member (fused solder ball). For example, a pressure of the compressed gas lower than a predetermined value may cause a clogging of the solder member in the nozzle, by the viscosity of the fused solder member.

On the other hand, a pressure of the compressed gas larger than the predetermined value may be capable of avoiding the influence of viscosity, but may cause the fused solder member to be scattered in the air, or to spread on or to bounce back from the surface of the object of soldering. The present invention, ejecting the solid-state solder member without utilizing compressed gas, can prevent such drawbacks caused by the fused solder member.

In order to prevent oxidation of the solder member, it is also possible, in the above-described embodiment, to add a known gas supply source for supplying a compressed gas, and to supply the containing portion 105 with an inert gas (compressed gas) such as nitrogen, thereby ejecting the solder member under provision of the compressed gas. Even in such construction, the solder member ejected from the nozzle is in a solid state, so that the pressure of the compressed gas can be selected suitably for deposition onto the substrate, without considering the viscosity of the fused solder member. Therefore, no difficulty is caused in the deposition of the solder member.

### Embodiment 2

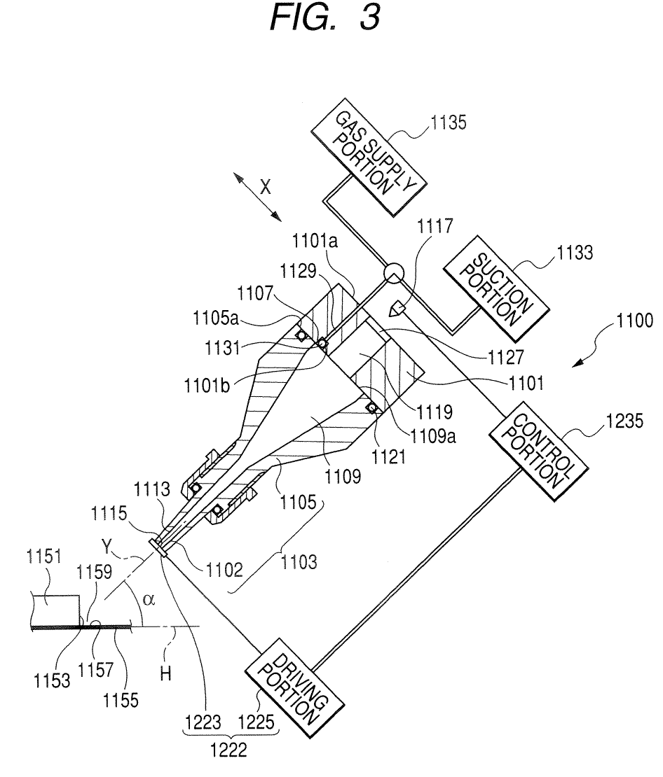

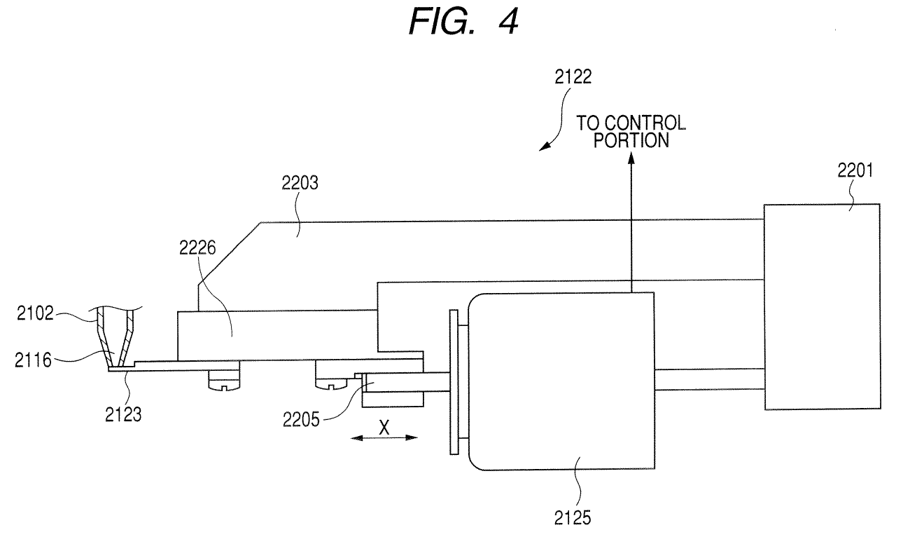

In the following, described is an embodiment 2 of the soldering apparatus, having a construction of supplying the solder member with compressed gas thereby ejecting the solder member. FIG. 3 is a partial cross-sectional view of the soldering apparatus in the embodiment 2 of the present invention.

A slider 1151 and a flexture 1155 to be soldered are so positioned that a slider electrode 1153 and a flexture electrode 1157 thereof form an upward angle of about 90°, and each electrode is provided at least in four units. A solder nozzle 1107 is so positioned as to correspond to an approximate center position of a width direction (front-back direction with respect to the plane of FIG. 3) of a groove 1159 of about 90°, defined by the electrodes of the slider 1151 and the flexture 1155, temporarily positioned by an adhesive material or a holding mechanism, and the solder ball 1131 is ejected and fused to execute an electrical adjoining of the electrodes. In contrast to the embodiment 1, the flexture, mounted with the slider 1151, is positioned substantially horizontally.

A soldering apparatus 1100 includes a solder supply unit 1101 for conveying a solder member from an unillustrated reservoir to a containing portion, namely a cover member, and nozzle assembly 1103 for ejecting the solder member. The soldering apparatus 1100 is so arranged as to have an inclination angle α in the ejecting direction (chain line Y) with respect to a horizontal direction (chain line H). The inclination angle may be suitably changed according to the soldering position of the object for soldering. More specifically, the inclination angle may be selected at any angle from 0° (ejection in the substantially horizontal direction) to 360°.

The solder supply portion 1101 of substantially cylindrical shape is a member detachably mounted on the nozzle assembly 1103, and serves also as a cover member of the nozzle assembly 1103. The solder supply portion 1101 is provided with a heat ray path in which a laser beam passes for fusing the solder member. The heat ray path is constituted of a laser introduction path 1119 and a laser beam transmitting portion 1127. The laser introduction path 1119 penetrates between faces 1101a and 1101b, corresponding to a shorter direction of the solder supply portion 1101. An aperture at the upper face 1101a of the laser introduction path 1119 is closed by a laser beam transmitting portion 1127 formed by a glass material which can transmit the laser beam, whereby the laser beam alone can pass. The laser introduction path 1119 is opened at the side of the lower face 1110b. When the solder supply portion 1101 is mounted on the nozzle assembly 1103, the laser introduction path 1119 communicates with an internal space 1109 of the nozzle main body 1105, to be described later. Thus, in the embodiment 1, the laser introduction path and the solder ball introduction path are provided separately, but, in the embodiment 2, the laser introduction path and the solder ball introduction path are constructed as a same introduction path.

The solder supply portion 1101 is provided, in radially outward position of the laser introduction path 1119, with a suction path 1129 which penetrates between the upper face 1101a and the lower face 1101b. The suction portion 1129 is connected with a suction portion 1133 at the side of the upper face 101a. The suction path 1129 is connected, at the side of the lower face 1101b, to a single recess 1131 which is open downwards. The recess 1131 is a cylindrical groove having a hollow interior. The diameter of an internal peripheral wall of the recess 1131 is slightly larger than the external diameter of the solder ball 1117, while the length of the recess 1131 in a direction perpendicular to the lower face 1101b is selected equal to or smaller than the external diameter of the solder ball 1117. Also the diameter of the suction path 1129, connected to the recess 1131, is made smaller than the diameter of the internal peripheral wall of the recess 1131. Therefore, when a suction force is given from the suction portion 1133 to the suction path 1129, such suction force is applied through the recess 1131 to the solder ball 1117, thereby holding a solder ball in the recess 1131.

The end of the suction path 1129 at the side of the upper face 1101a is further connected to a gas supply portion 1135 for supplying a compressed gas. Thus, the suction path 1129 also functions as a gas supply path. A gas supply path, for providing the solder member with the compressed gas supplied from the gas supply portion 1135, is constituted of the suction path 1129, the recess 1131, and an internal space 1109 and a containing portion 1113 to be described later. The compressed gas is applied to the solder ball through the gas supply path, thus ejecting the solder ball. As the compressed gas, employed is an inert gas such as nitrogen gas.

Now the nozzle assembly 1103 will be described. The nozzle assembly 1103 includes a nozzle 1107 for ejecting the solder member, and a nozzle main body 1105 for holding the nozzle 1107. The nozzle main body 1105 has a substantially conical tubular shape, and an internal space 1109 provided therein has a shape pointed toward the end.

A solder introduction port 1109a, which is an aperture on the upper face 1105a of the nozzle main body 1105, has such a diameter that, in a state where the solder supply portion 1101 is mounted on the upper face 1105a of the nozzle main body 1105, the recess 1131 is positioned within the aperture area of the solder introduction port 1109a. Therefore, the recess 1131 directly communicates with the solder introduction port 1109a. Thus the solder ball 1117 held in the recess 1131 is released, and, when the compressed gas is applied, moves from the solder introduction port 1109a to the internal space 1109 of the nozzle main body 1105. Thus, the internal space 1109 functions as a supply path for the solder member.

The internal space 1109 of the nozzle main body 1105 also functions as a laser beam path in which the laser beam passes.

An O-ring 1121 is mounted on the upper face 1105a of the nozzle main body 1105. When the lower face 1101b of the solder supply portion 1101 is mounted on the upper face 1105a of the nozzle main body 1105, the nozzle main body 1105 and the solder supply portion 1101 is closely sealed through the O-ring 1121. Also for fixing the solder supply portion 1101 to the nozzle assembly 1103, there is employed known means such as a mechanism of providing the solder supply portion 1101 with a load larger than the internal pressure of the internal space 1109, thereby pressing it to the nozzle assembly.

The nozzle 1107 is a tubular member of a pointed shape, which includes a containing portion 1113 therein and is opened on both ends in the longitudinal direction. An upper end of the nozzle 1107 is mounted on the nozzle main body 1105, while a lower end constitutes an aperture 1115 for ejecting the solder ball 1117 toward the exterior of the nozzle.

Also the internal wall of the containing portion 1113 of the nozzle 1107 and the aperture 1115 have a diameter at least larger than the external diameter of the solder ball 1117, so that the solder ball 1117 can freely roll and move in the nozzle 1107.

Further, the soldering apparatus 1100 of the embodiment 2 includes a hold-release unit which releasably holds a solid-state solder ball 1117 in a position, separated by a predetermined distance from the soldering position (angled portion 1159) on the flexture electrode 1157 where the solder member is to be deposited, a heating unit or a laser apparatus 1118 which provides the solder ball 1117 with a heat ray thereby heat fusing the solder ball 1117, and a control portion 1235 which synchronizes a timing for releasing the hold in the hold-release unit and a timing of heating by the heating unit.

The hold-release unit is constituted of a nozzle assembly 1103 and an open/close unit 1222. The open/close unit 1222 is constituted of a stopper 1223 for open/closing the aperture 1115 of the nozzle 1107, and a drive unit 1225 for driving the stopper 1223 (moving in the x-direction).

Also the interior of the containing portion 1113 of the nozzle 1107 constitutes a laser beam path for passing the laser beam. In the embodiment 2, members are arranged in such a manner that the laser introduction path 1119 of the solder supply portion 1101, the internal space 1109 of the nozzle main body 1105, the containing portion 1113 of the nozzle 1107 and the aperture 1115 have central axes arranged on a straight line. Therefore the laser beam passing through the laser introduction path 1119 enters the internal space 1109, then passes the containing portion 1113 of the nozzle 1107 and irradiates the solder ball 1117.

Then, when the solder supply portion is mounted on the nozzle assembly, the laser introduction path 1119, the internal space 1109 and the containing portion 1113 are closed except for the aperture 1115.

In the soldering apparatus of the above-described structure, the conveying step for the solder ball 1117 is executed in the following manner. The suction portion 1133 is activated to hold the solder ball 1117 in the recess 1131 under suction. The solder supply portion 1101 in a state of suction holding the solder ball 1117 is moved in the x-direction, thus mounting the solder supply portion 1101 on the nozzle assembly 1103. This state is illustrated in FIG. 4. Then, the suction force of the suction portion 1133 to the solder ball 1117 is released. Then, the gas supply portion 1135 is activated to apply the compressed gas to the solder ball 1117, thus introducing the solder ball 1117 into the internal space 1109. The solder ball 1117 passes through the internal space 1109 and the containing portion 1113 of the nozzle 1107, thus reaches the proximity of the aperture 1115, and is held by the stopper 1223 and the nozzle 1107.

The soldering apparatus utilizing the solder supply portion 1101 of the above-described structure functions in the following manner.

After the conveying state of the solder ball 1117, the soldering apparatus 1100 containing thus loaded solder ball 1117 is subjected to a positioning operation.

The soldering apparatus is so moved that the nozzle aperture 1115 is placed at a position separated by a predetermined distance, in a direction of an inclination angle α from the horizontal direction H, from an approximate center position of a width direction of a groove 1159, defined by the slider electrode 1153 and the flexture electrode 1157, to which the fused solder ball 1117 is to be deposited. The moving mechanism utilizes, for example, a known structure capable of movement in three axes (x-axis, y-axis and z-axis).

When the suction force on the solder ball 1117 from the suction portion 1133 is terminated, the compressed gas is applied from the gas supply portion 1135 through the suction path 1129 onto the solder ball 1117. The solder ball 1117 held in the recess 1131 moves toward the aperture 1115 and is positioned on the stopper 1223 closing the aperture 1115.

Then the drive portion 1225 for the stopper 1223 is activated to move the stopper 1223, thereby opening the aperture 1115. After the opening of the aperture 1115, a laser irradiation is executed to fuse the solder ball 1117. The compressed gas may be applied suitably before and after the opening of the stopper. More specifically, before the opening of the stopper, the application of compressed gas positions the solder ball on the stopper, and, after the opening of the stopper, the solder ball is ejected by the compressed gas from the aperture 1115 to the exterior of the nozzle 1107.

The laser beam oscillated from the laser apparatus 1118 passes the laser transmitting portion 1127, the laser introduction path 1119, and the internal space 1109 and irradiates and fuses the solder ball of solid state, ejected from the aperture 1115.

The fused solder ball 1117 is deposited on the predetermined position (angled portion 1159), thereby completing the soldering.

The soldering apparatus, equipped with the aforementioned solder supply portion, can hold the solder ball within a closed space, so that the pressure of the compressed gas utilized for ejection can be easily and securely selected, and the solder ball can be securely ejected.

Also, regardless of the ejecting direction of the solder ball from the soldering apparatus, the solder ball can be deposited to a predetermined soldering position.

### (Structure of Open/Close Unit)

Now, a specific example of the structure of the open/close unit, applicable to the embodiments 1 and 2, will be described with reference to the accompanying drawings.

### Structural Example 1

A structural example 1 provides an open/close unit utilizing an electromagnetic solenoid type actuator as a drive source. FIG. 4 is an elevation view of an open/close unit equipped with an electromagnetic solenoid type actuator, in a state where the aperture is closed. In the drawing, an open/close unit 2122 of the structural example 1 includes a stopper 2123 for closing an aperture 2116 of a nozzle 2102, a drive portion or an electromagnetic solenoid type actuator 2125 for executing an open/close operation by moving the stopper 2123 in the x-direction, an open/close unit main body 2201 for holding the stopper 2116 and the electromagnetic solenoid type actuator 2125, and arm member 2203 supported horizontally reciprocably by the open/close unit main body 2201.

The electromagnetic solenoid type actuator includes a tubular case, an unillustrated electromagnetic coil provided in the case, an unillustrated fixed iron core provided in the electromagnetic coil, unillustrated movable iron core so provided as to be contactable with and separable from the fixed iron core, and a rod 2205 mounted on the movable iron core.

Also the arm member 2203 extends in the horizontal direction (lateral direction in FIG. 4), and an end thereof is connected to the open/close unit main body 2201. The other end of the arm member 2203 is connected, through a connecting member, to an end of a piston 2205 of the actuator 2125 and the stopper 2123. Therefore, when the rod 2205 reciprocates (in x-direction), the stopper 2123 reciprocates in the x-direction through the arm 2203.

The open/close unit 2122 of the above-described structure, upon receiving a drive signal from the control portion, moves in the x-direction (to the right in the drawing), thereby opening the aperture 2116 or moves to the left thereby closing the aperture 2116.

### Structural Example 2

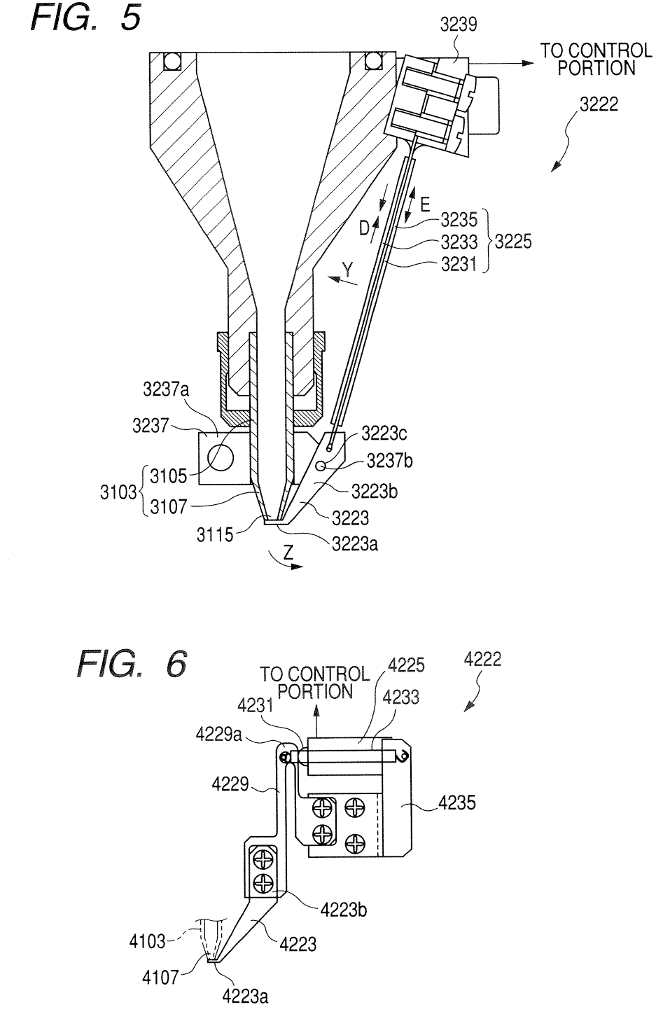

A structural example 2 provides an open/close unit utilizing a piezo actuator. FIG. 5 is a cross-sectional view of a nozzle assembly, utilizing an open/close unit equipped with piezo actuator. The drawing illustrates an open/close unit 3222 in a state where an aperture 3115 is closed. Since the nozzle assembly 3103 has a similar structure as the nozzle assembly 1103 illustrated in FIG. 3, description will be made only on different portions.

On the external periphery of a nozzle main body 3105, mounted are a stopper 3223 constituting the open/close unit 3222 and a piezo actuator 3225 constituting a drive portion for driving the stopper 3223.

The stopper 3223 has an L-shaped structure including a flat portion 3223a for closing an aperture 3115 of the nozzle 3107 and a stopper main body portion 3223b continued from the flat portion 3223a through a bent portion. The stopper main body portion 3223b has a hole 3223c into which a pin 3237a of a fixed block 3237 to be described later is fitted.

A first fixed block 3237 for fixing the stopper 3223 to the nozzle main body 3105 is constituted of two block pieces 3237a (only one being illustrated) provided with a bent portion provided along the external periphery of the nozzle main body 3105 and a flange portion fixed for example with a screw. On the flange of a block piece 3237a, provided is a pin 3237b of a diameter somewhat smaller than the diameter of the hole 3223c of the stopper 3223, whereby the stopper 3223 can rotate about the pin 3237b. The stopper 3223 is mounted on the block piece 3237a by the pin 3237b, and two block pieces are positioned on around the nozzle main body 3105. Thus the block pieces are mounted on the nozzle main body 3105 for example with screws.

The stopper 3223 is connected to an end of the drive portion, namely a piezo actuator 3225. The actuator 3225 is so-called bending actuator, constructed by adhering piezo elements 3233, 3235 on both sides of a plate-shaped ceramic member 3231. The other end of the actuator is fixed to the nozzle main body 3105, through a second fixed block 3239, which is fixed in an upper part of the nozzle main body 3105.

In a stationary state (state illustrated in FIG. 5) of the actuator, the stopper 3223 closes the aperture 3115. For opening the aperture 3115, voltages are applied to the piezo elements 3233, 3235 to contract a piezo element 3233 and to extend the other piezo element 3235, thereby bending the actuator 3225 in a direction closer to the nozzle main body 3105 (direction of arrow Y). The stopper 3223 connected to the actuator 3225 rotates about the pin 3223c (direction z), thereby opening the aperture 3115.

### Structural Example 3

The structural example 3 provides an open/close unit utilizing a piezo actuator of another type. FIG. 6 is an elevation view of the open/close unit. FIG. 6 illustrates a state where an aperture 4107 is closed by a stopper 4223. In the drawing, the nozzle 4107 of the nozzle assembly is illustrated by imaginary lines, and the nozzle assembly is not explained as it has a structure same as the nozzle assembly 3103 in FIG. 5.

The open/close unit 4222 includes a stopper 4223, and a piezo actuator 4225 constituting a drive portion for driving the stopper 4223. The stopper 4223 has an approximately L-shaped structure including a flat portion 4223a for closing the aperture 4107 and a fixed portion 4223b connected to a plate spring 4229 to be described later.

The actuator 4225 is so-called stacked piezo actuator. The actuator 4225 is constituted of a cylindrical casing 4227 having an aperture at an end, a stacked piezo element (not shown) provided in the casing 4227, and a protruding portion 4231 connected to the piezo element and movably protruding from the aperture of the casing 4227. The other closed end of the casing 4227, opposed to the aperture, is fixed to a main body 4235 of the open/close unit. A coil spring 4233 is provided along the longitudinal direction of the actuator 4225, between a bent portion 4229a of the plate spring 4229 and the main body 4235 of the open/close unit. The coil spring 4233 applies a pressure to the piezo element.

In the above-described structure, when a voltage is applied to the piezo element, the piezo element stretches to cause the protruding portion 4231 to press the bent portion 4229a of the plate spring leftward, whereby the bent portion 4229a of the plate spring is inclined (bent) toward left, and the connected stopper 4223 rotates toward right, thereby opening the aperture 4107. In a state without the voltage application, the piezo element returns to the stationary state (contracted state), whereby the aperture 4107 is closed.

### EXAMPLES

In the following, examples of soldering operation with the soldering apparatus of embodiment 2 will be described.

The object of soldering was a gold electrode member having a flat surface of 0.95 mm×0.6 mm. The used solder ball was a spherical member of a diameter of 110 μm. Nitrogen gas was used as the compressed gas. Also the distance from the nozzle end to the soldering position of the work was 0.5 mm. The used laser was a YAG laser of a wavelength of 1064 nm, and the irradiation time of the laser beam was selected as 0.3 msec from the start of irradiation.

The laser beam spot had a diameter of φ200 μm at the soldering position.

Results of Examples 1 to 3 of soldering operations, conducted by changing the time from the opening of the shutter to the start of laser irradiation and changing the pressure of the compressed gas, are shown below.

| | elapsed time from | compressed | |
|---|---|---|---|
| Example | stopper opening | gas pressure | state of soldering |
| 1 | 800 μsec | 1.0 kPa | satisfactory |
| 2 | 700 μsec | 2.0 kPa | satisfactory |
| 3 | 600 μsec | 2.5 kPa | satisfactory |

As described in the table above, the soldering was executed satisfactorily in the predetermined position, in any of Examples 1 to 3.

### Embodiment 3

The stoppers of embodiments 1 and 2 illustrated in FIGS. 1A, 1B and 3, and the stopper of structural example 1 in FIG. 4 are so constructed as to open or close the aperture of the nozzle, by a movement in a direction perpendicular to the ejecting direction.

In the structure illustrated in FIG. 1B, when the aperture 106 is completely opened by the stopper 123, the stopper 123 moving in the x-direction applies a force component toward right to the solder ball 107 on the stopper 123, whereby the ejecting direction of the solder ball 107 may be deviated to a direction inclined from the vertical direction. It is essential to remove such fluctuation in the ejecting direction, in order to achieve an improvement in the precision of the depositing position of the solder ball, required for a higher density in the arrangement of the electronic components.

On the other hand, the soldering apparatus of embodiment 2 illustrated in FIG. 3 has a structure of ejecting the solder ball by compressed gas. Therefore, in comparison with the soldering apparatus of embodiment 1 based on ejection of the solder ball, the soldering apparatus of embodiment 2 can relatively reduce the influence of stopper movement on the deviation of ejecting direction in the x-direction, but cannot completely eliminate such influence.

Therefore, there is desired a construction capable of preventing that the stopper movement in opening the aperture applies a force component, in a direction same as the moving direction of the stopper, to the solder ball, thereby causing a fluctuation in the ejecting direction of the solder ball. A soldering apparatus of embodiment 3, proposed for accomplishing such object, will be described below.

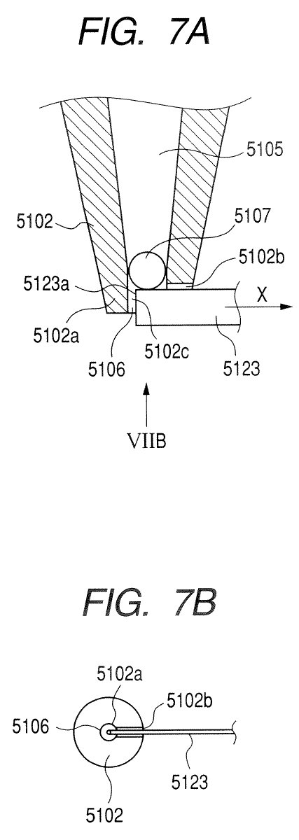

FIG. 7A is a cross-sectional view of a nozzle of a soldering apparatus of the embodiment 3, and FIG. 7B is a bottom view of the nozzle, seen from a direction VII in FIG. 7A. The drawings illustrates a state where the stopper is closed and the solder ball is supported by the stopper in the containing space. FIGS. 7A and 7B illustrate only the nozzle and the stopper in the soldering apparatus of the embodiment 3, and other structures are omitted as they are similar to those of the soldering apparatus illustrated in FIGS. 1A, 1B and 3.

A nozzle 5102 constituting a tubular nozzle assembly has an aperture 5106 of a diameter larger than the external diameter of a solder ball 5107, and a containing space 5105 for containing the solder ball 5107, and, on a peripheral wall 5102a of the nozzle 5102, there is provided a slit 5102b (or groove) penetrating in the radial direction and extending axially from the end of the nozzle.

A support member for supporting the solder ball 5107 is a stopper 5123, and the stopper 5123 is rendered movable by connection to an unillustrated drive portion (cf. 125 in FIGS. 1A and 1B). The stopper 5123 is formed by a substantially rectangular thin plate member. Also the stopper 5123 has a width (in vertical direction in FIG. 7B), somewhat smaller than the width of the slit 5102b, in order that the stopper 5123 can be inserted into the slit 5102b. Therefore, the stopper 5123 extends into the containing space 5105, through the slit 5102b. The stopper 5123 in the extended state supports the solder ball 5107, at the upstream side of the aperture 5106 in the ejecting direction. The stopper 5123 can be inserted into or extracted from the containing space 5105 by the drive portion (movement in the lateral direction in the drawing).

Also the slit 5102b of the nozzle 5102 extends in a guide area 5102c, having an internal diameter same as that of the aperture 5106. Thus, in the guide area 5102c from the support position of the solder ball 5107 on the stopper 5123 to the aperture 5106, the nozzle 5102 has an internal diameter same as that of the aperture 5106. The guide area 5102c functions as a guide for directing the solder ball to the predetermined ejecting direction. It is therefore desirable to select the internal diameter of the aperture 5106 and the guide area 5102c slightly larger than the solder ball 5107, thereby enabling the guide area 5102c and the aperture 5106 to direct the solder ball 5107 into the predetermined ejecting direction.

In the present embodiment, the guide area 5102c is formed from the support position of the solder ball to the aperture 5102a, but such construction is not restrictive. The guide area may be formed in a part of the area from the support position of the solder ball to the aperture.

In the above-described structure, the drive portion (cf. 125 in FIGS. 1A and 1B) moves the stopper 5123 in the x-direction, thereby moving the stopper 5123 to the outside of the containing space 5105, namely to the radial outside of the internal periphery of the guide area 5102c and releasing the support of the solder ball 5107. When the stopper 5123 moves, the solder ball 5107 is ejected toward below the nozzle 5102, by its weight or by compressed gas. In this operation, the solder ball 5107 is directed into the predetermined ejecting direction by the guide area 5102c. Therefore, the precision of deposition of the solder ball 5107 can be improved.

In the above-described embodiment, the stopper is completely extracted to the outside of the internal periphery of the guide area 5102c, but it is also possible to execute a movement until the end face 5123a of the stopper 5123 comes to a position, coplanar with the internal periphery of the guide area 5102c and to select the vertical length of the stopper 5123 (in vertical direction in FIG. 7A) substantially same as the vertical length of the slit 5102b. In such structure, the end face 5123a of the slit and the guide area 5102c function as the guide for the solder ball 5107, so that, even in case the solder ball is biased in the x-direction by the movement of the stopper, it can be securely corrected into the predetermined ejecting direction.

The stopper 5123 described in the present embodiment 3 is applicable not only in FIGS. 1A, 1B and 3 but naturally also as the stopper in the structural examples 1 to 3.

Also the shape and the position of the stopper and the slit are not limited to those in the above-described embodiment. For example, in case of utilizing a rod-shaped member as the stopper, it is also possible to provide a penetrating hole, radially penetrating the peripheral wall in a position above the aperture (upstream side in the ejecting direction) and to execute supporting and release of the solder ball by inserting or extracting the rod-shaped member into or from the penetrating hole.

### (Variation)

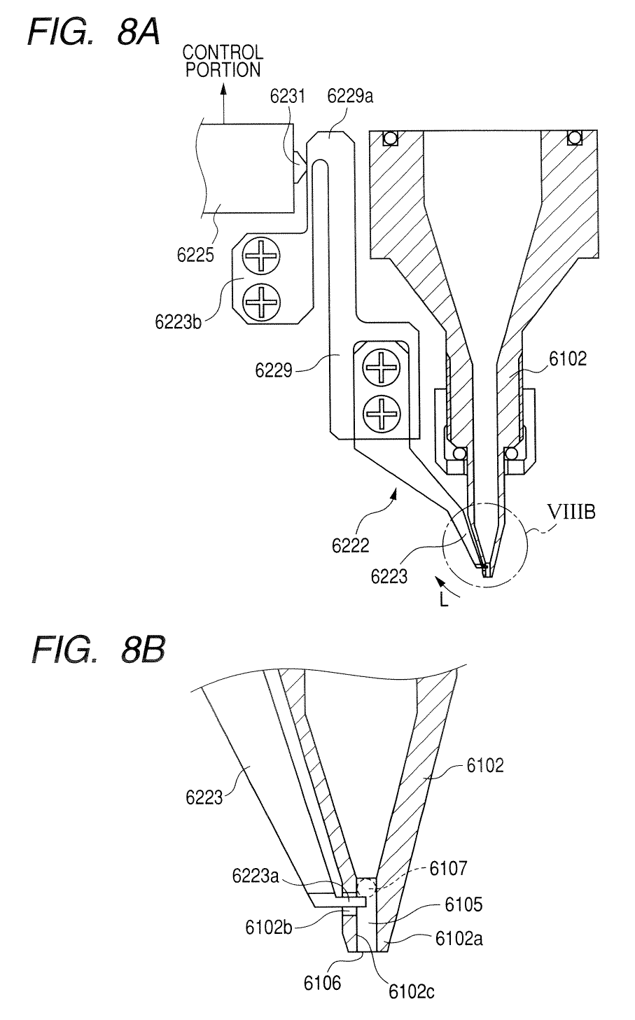

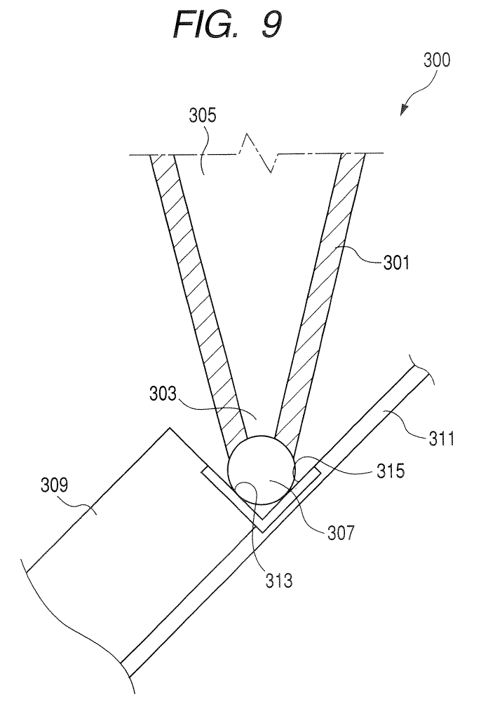

In the following, there will be described a variation of the third embodiment, in which the stopper is inserted or extracted into or from the penetrating hole formed in the peripheral wall of the nozzle. FIG. 8A is a cross-sectional view of the soldering apparatus in a variation of the embodiment 3, and FIG. 8B is a magnified view of a portion VIIIB in FIG. 8A. The drawings illustrate a state where the stopper is closed and the solder ball is held by the stopper in the containing space. The soldering apparatus of the variation illustrated in FIGS. 8A and 8B is equipped with an open/close unit utilizing a piezo actuator.

The soldering apparatus includes a nozzle assembly and an open/close unit. A nozzle 6102 constituting a tubular nozzle assembly has an aperture 6106 of a diameter larger than the external diameter of a solder ball 6107, and a containing space 6105 communicating with the aperture 6106 and containing the solder ball 6107, and the peripheral wall 6102a of the nozzle 6102 has a penetrating hole 6102b, penetrating in the radial direction. An open/close unit 6222 is provided in the proximity of the distal end of the nozzle 6102.

The open/close unit 6222 includes a stopper 6223 and a piezo actuator 6225, serving as drive portion for driving the stopper 6223. The actuator 6225 is a stacked piezo actuator. The actuator 6225 has a structure same as that of the actuator illustrated in FIG. 6. An unillustrated coil spring is provided along the longitudinal direction of the actuator 6225 and between a bent portion 6229a of the plate spring 6229 and the open/close unit main body 6235. The coil spring applies a pressure to the piezo element, and maintains the plate spring 6229 in a contracted state when the piezo element is not actuated.

The stopper 6223, serving as support member for supporting the solder ball 6107, is connected to the piezo actuator drive portion 6225 for moving the stopper and to the plate spring 6229. The stopper 6223 has an approximately L-shaped structure including a flat portion 6223a, which extends into the containing space 6105 through the penetrating hole 6102b for supporting the solder ball 6107, and a fixed portion 6223b connected to the plate spring 6229. Also the stopper 6223 has a width somewhat smaller than the width of the penetrating hole 6102b (in front-back direction in FIGS. 8A and 8B) in such a manner that the stopper 6223 can be inserted into the penetrating hole 6102b of a vertically oblong cross section (oval shape). Therefore, the stopper 6223 extends into the containing space 6105, through the penetrating hole 6102b. The stopper 6223 in the extended state supports the solder ball 6107, at the upstream side of the aperture 6106 in the ejecting direction. The flat portion 6223a at the distal end of the stopper 6223 can be inserted into or extracted from the containing space 6105 by the drive portion 6222.

Also the penetrating hole 6102b of the nozzle 6102 extends in a guide area 6102c. In the guide area 6102c from the support position of the solder ball 6107 on the stopper 6123 to the aperture 6106, the nozzle 6102 has an internal diameter same as that of the aperture 6106. The guide area 6102c functions as a guide for guiding the solder ball to the predetermined ejecting direction. It is therefore desirable to select the internal diameter of the aperture 6106 and the guide area 6102c slightly larger than the solder ball 6107, thereby enabling the guide area 6102c and the aperture 6106 to direct the solder ball 6107 into the predetermined ejecting direction.

In the above-described structure, when a voltage is applied to the piezo element, the piezo element stretches to cause the protruding portion 6231 to press the bent portion 6229a of the plate spring leftward, whereby the bent portion 6229a of the plate spring is inclined (bent) toward right (indicated by an arrow 1), and the connected stopper 6223 rotates toward right, thereby opening the aperture 6106. In a state without the voltage application, the piezo element returns to the stationary state (contracted state), whereby flat portion 6223a protrudes into the containing space 6105.

The drive portion 6222 moves the stopper 6223 in the x-direction, thereby moving the stopper 6223 to the outside of the containing space 6105, namely to the outside of the guide area 6102c and releasing the support of the solder ball 6107. When the stopper 6223 moves, the solder ball 6107 is ejected toward below the nozzle 6102, by its weight or by compressed gas. In this operation, the solder ball 6107 is directed into the predetermined ejecting direction by the guide area 6102c. Therefore, the precision of deposition of the solder ball 6107 can be improved.

The aforementioned embodiments 1, 2 and 3 utilize a laser apparatus, but the solder ball, namely the solder member, may be heat fused by a light of a halogen lamp or a hot air. Also a spherical solder ball is employed as the solder member, but the shape thereof is not particularly restricted to a spherical shape.

Also instead of the structure in which the optical axis of the laser beam, the central axis of the laser introduction path, the central axis of the containing portion and the central axis of the aperture are aligned along the same direction, there may also be adopted a laser apparatus capable of causing a scan motion of the laser beam along the trajectory of the solder ball ejected from the aperture, and it is thus unnecessary to align the optical axis of the laser beam and the ejection path of the solder ball after ejection.

Also the hold-release member is not limited to the foregoing embodiments. For example, the open/close mechanism of the nozzle may be formed by a diaphragm structure or a divided structure constituted of plural fins.

In the adjoining apparatus of the present invention, the irradiating direction of the laser beam may be made same as the ejecting direction of the conductive member.

The adjoining apparatus of the present invention is an adjoining apparatus which places a heat fused electrically conductive member in an adjoining position for adjoining a first member and a second member, thereby electrically adjoining the first member and the second member, the adjoining apparatus being configurable as including:

a tubular nozzle assembly having a containing space which contains the conductive member and an aperture which communicates with the containing space, through which the conductive member, contained in the containing space, is ejected to the adjoining position, and which has a diameter larger than a diameter of the conductive member; and

a support member for releasably supporting the conductive member in the containing space, in a position separated by a predetermined distance from the adjoining position;

an ejection unit which ejects the conductive member to the adjoining position;

a heating unit which provides the conductive member with heat by an irradiation with a heating ray thereby heating the conductive member; and

a control unit which synchronizes a timing of releasing the hold by the hold member and a timing of heating by the heating unit;

wherein the nozzle assembly includes a tubular guide area of an internal diameter same as the diameter of the aperture, in a region from the position of the conductive member, supported by the support member, to the aperture.

The compressed gas to be employed in the ejection unit of the present invention may be an inert gas (such as nitrogen) or a gas capable of reducing the conductive member (such as hydrogen).

The present invention may be realized in various forms without departing from the fundamental gist thereof. Therefore, the embodiments described above are only for the purpose of exemplary description, and are naturally not to restrict the present invention.

This application claims priority from Japanese Patent Application No. 2006-71907 filed on Mar. 16, 2006, which is hereby incorporated by reference herein.

What is claimed is:

1. A nozzle unit for use in an adjoining apparatus which places a heat fused electrically conductive member in an adjoining position for adjoining a first member and a second member, thereby electrically adjoining the first member and the second member, the nozzle unit comprising:
a tubular nozzle assembly having a containing space which contains the conductive member and an aperture which communicates with the containing space, through which the conductive member, contained in the containing space, is ejected to the adjoining position, and which has a diameter larger than a diameter of the conductive member; and
a support member for releasably supporting the conductive member in the containing space;
wherein the nozzle assembly comprises a tubular guide area of an internal diameter same as the diameter of the aperture, in a region from the position of the conductive member, supported by the support member, to the aperture.

2. The nozzle unit according to claim 1, wherein the nozzle assembly has a hole or a slit penetrating a peripheral wall thereof and communicating with the containing space; and the support member has a stopper for supporting the conductive member through the hole or the slit.

3. An adjoining apparatus which places a heat fused electrically conductive member in an adjoining position for adjoining a first member and a second member, thereby electrically adjoining the first member and the second member, the adjoining apparatus comprising:
a tubular nozzle assembly having a containing space which contains the conductive member and an aperture which communicates with the containing space, through which the conductive member, contained in the containing space, is ejected to the adjoining position, and which has a diameter larger than a diameter of the conductive member; and
a support member for releasably supporting the conductive member in the containing space;
a heating unit which provides the conductive member with heat by an irradiation with a heating ray thereby heating the conductive member; and
a control unit which synchronizes a timing of releasing the support by the support member and a timing of heating by the heating unit;
wherein the nozzle assembly includes a tubular guide area of an internal diameter same as the diameter of the aperture, in a region from the position of the conductive member, supported by the support member, to the aperture.

4. The adjoining apparatus according to claim 3, wherein the heating unit is a laser apparatus, and the heat ray is a laser beam.

5. The adjoining apparatus according to claim 4, wherein the laser beam has an irradiating direction same as an ejecting direction of the conductive member.

6. An adjoining apparatus which places a heat fused electrically conductive member in an adjoining position for adjoining a first member and a second member, thereby electrically adjoining the first member and the second member, the adjoining apparatus comprising:
a tubular nozzle assembly having a containing space which contains the conductive member and an aperture which communicates with the containing space, through which the conductive member, contained in the containing space, is ejected to the adjoining position, and which has a diameter larger than a diameter of the conductive member; and
a support member for releasably supporting the conductive member in a position present in the containing space and separated by a predetermined distance from the adjoining position;
an ejection unit which ejects the conductive member to the adjoining position;
a heating unit which provides the conductive member with heat by an irradiation with a heating ray thereby heating the conductive member; and
a control unit which synchronizes a timing of releasing the support by the support member and a timing of heating by the heating unit;
wherein the nozzle assembly includes a tubular guide area of an internal diameter same as the diameter of the aperture, in a region from the position of the conductive member, supported by the support member, to the aperture.

7. The adjoining apparatus according to claim 6, wherein the heating unit is a laser apparatus, and the heat ray is a laser beam.

8. The adjoining apparatus according to claim 6, wherein the ejection unit is a compressed gas supply unit which applies a compressed gas to the conductive member in the containing space.

9. The adjoining apparatus according to claim 7, wherein the ejection unit is a compressed gas supply unit which applies a compressed gas to the conductive member in the containing space.

10. The adjoining apparatus according to claim 3, wherein the support member is driven by a piezo actuator.

11. The adjoining apparatus according to claim 4, wherein the support member is driven by a piezo actuator.

12. The adjoining apparatus according to claim 5, wherein the support member is driven by a piezo actuator.

13. The adjoining apparatus according to claim 6, wherein the support member is driven by a piezo actuator.

14. The adjoining apparatus according to claim 7, wherein the support member is driven by a piezo actuator.

15. The adjoining apparatus according to claim 8, wherein the support member is driven by a piezo actuator.

16. The adjoining apparatus according to claim 9, wherein the support member is driven by a piezo actuator.
